(19) United States
(12) Patent Application Publication
(10) Pub. No.: US 2006/0288365 A1
(43) Pub. Date: Dec. 21, 2006

(54) Image processing apparatus, and control method of image storing system having the same

(75) Inventor: Joon-ho Jeong, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/352,300

(22) Filed: Feb. 13, 2006

(30) Foreign Application Priority Data
Jun. 17, 2005 (KR) 2005-0052613

(51) Int. Cl. H04N 5/445; G06F 13/00

(52) U.S. Cl. 725/39

(57) ABSTRACT

A method of controlling an image storing system comprising a plurality of external devices, and an image processing apparatus connected to the plurality of external devices, wherein the image storing system is capable of storing a video signal in the plurality of external devices. The method includes determining whether a function related to storing the video signal is selected; requesting state data about operation states of the plurality of external devices if the function related to storing the video signal is selected; receiving at the image processing apparatus the requested state data from the plurality of external devices; and displaying an external device state menu showing the operation states corresponding to the plurality of external devices based on the received state data.

### CROSS-REFERENCE TO RELATED APPLICATIONS

This application claims priority from Korean patent Application No. 2005-0052613, filed on Jun. 17, 2005, in the Korean Intellectual Property Office, the disclosure of which is incorporated herein by reference.

### BACKGROUND OF THE INVENTION

1. Field of the Invention

The present invention relates to an image processing apparatus and a control method of an image storing system having the same, and more particularly, to an image processing apparatus and a control method of an image storing system having the same, in which a user can easily and effectively check states of a plurality of external devices when the user manipulates a storing operation, so that the storing operation is more conveniently and reliably performed.

2. Description of the Related Art

A conventional storing operation for an image is directly performed in a storing device. However, the storing operation has recently been performed in a selected external device connected to an image processing apparatus using communication technology such as Institute of Electrical and Electronics Engineers (IEEE) 1394. Hereinafter, a television (TV) will be described as a representative image processing apparatus.

Meanwhile, in the case of a digital TV, as the number of channels has recently been increasing by leaps and bounds, a broadcasting station provides the digital TV with electronic program guide (EPG) information included in a broadcasting signal. Thus, the TV extracts the EPG information from the broadcasting signal and displays an EPG information picture corresponding to the EPG information, thereby allowing a user to get information about various broadcasting programs, e.g., information about the title, the start time, the end time, etc. of a reproducing program.

In a conventional image storing method for the TV capable of displaying the EPG information, a program being currently reproduced or a program to be reproduced is selected through the EPG information, and one external device among the external devices connected to the TV is selected through the EPG information, thereby storing the data of the selected program in the selected external device.

However, in the conventional image storing method, an image storing command is one-sidedly given from the TV to the selected external device without considering the operation states of the plurality of external devices connected to the TV. Therefore, it is actually unreliable that the selected storing device normally performs the storing operation. In other words, only after finishing the storing operation, a user can check whether the storing operation is performed normally or abnormally. Consequently, a user is confused at using an image storing function.

### SUMMARY OF THE INVENTION

The present invention provides an image processing apparatus and a control method of an image storing system having the same, in which a user can easily and effectively check states of a plurality of external devices when the user manipulates a storing operation, so that the storing operation is more conveniently and reliably performed.

According to an aspect of the present invention, there is provided a method of controlling an image storing system comprising a plurality of external devices, and an image processing apparatus connected to the plurality of external devices and which is capable of storing a video signal in the plurality of external devices, the method comprising determining whether a function related to storing the video signal is selected; allowing the image processing apparatus to request state data about operation states of the plurality of external devices when the function related to storing the video signal is selected; allowing the image processing apparatus to receive the requested state data from the plurality of external devices; and displaying an external device state menu showing the operation states corresponding to the plurality of external devices on the basis of the received state data.

According to an aspect of the present invention, the displaying the external device state menu comprises displaying storing-enabled external devices and storing-disabled external devices among the plurality of external devices as storing-enabled external device items and storing-disabled external device items, respectively, on the basis of the state data, and displaying the storing-enabled external device items and the storing-disabled external device items differently from each other.

According to an aspect of the present invention, the method further comprises selecting an EPG information picture to be displayed; and selecting a program for a storing operation on the displayed EPG information picture.

According to an aspect of the present invention, the displaying the external device state menu comprises displaying the external device items corresponding to the external devices, which are reproducing or storing another program, as the storing-disabled external device item with a first icon for representing a reproducing/storing state on the basis of the state data.

According to an aspect of the present invention, the displaying the external device state menu comprises displaying the external device items corresponding to the external devices, which have no storing medium for storing the video signal, as the storing-disabled external device item with a second icon for representing a no storing medium state on the basis of the state data.

According to an aspect of the present invention, the displaying the external device state menu comprises displaying the external device items corresponding to the external devices, which are provided with the storing medium having a remaining storing capacity smaller than that required for storing the video signal corresponding to the selected program, as the storing-disabled external device item with a third icon for representing a storing capacity deficiency on the basis of the state data.

According to an aspect of the present invention, the displaying the external device state menu comprises displaying the external device items corresponding to the external devices, which are abnormally operated, as the storing-disabled external device item with a fourth icon for representing an error state on the basis of the state data.

According to an aspect of the present invention, the state data includes at least one information among information about whether the external device are currently reproducing another program and storing another program, information about whether the external device is provided with a storing medium, information about a remaining storing capacity of the storing medium, and information about whether the external device normally performs the storing operation.

According to an aspect of the present invention, the method further comprises determining whether the plurality of external devices is connected to the image processing apparatus, and wherein the displaying the external device state menu comprises displaying the external device items corresponding to the external devices, which are not connected to the image processing apparatus, as the storing-disabled external device item with a fifth icon for representing a disconnected state.

According to an aspect of the present invention, the method further comprises determining whether a storing-device selecting function is selected to select the external device for storing the video signal of the selected program, and wherein the external device state menu is displayed when the storing-device selecting function is selected.

According to an aspect of the present invention, the method further comprises determining whether the external device of storing the video signal is abnormally stopped, and wherein the displaying the external device state menu comprises displaying the external device items corresponding to the external devices, of which the storing operation is abnormally stopped, as the storing-disabled external device item with a sixth icon for representing an abnormally stopped state.

According to an aspect of the present invention, the method further comprises determining whether an information key is input to check the state data; and displaying an icon explanation picture about operation states corresponding to the first through sixth icons when the information key is input.

According to an aspect of the present invention, the method further comprises determining whether the information key is input in the state that one of the external device items is pointed on the external device state menu; and displaying the state data corresponding to the pointed external device item when the information key is input.

According to an aspect of the present invention, the method further comprises determining whether the selected program is a storing-disabled program due to the copyright on the basis of the EPG information when the storing-device selecting function is selected; and displaying a storing-disability message warning of the storing disability when the selected program is the storing-disabled program.

According to an aspect of the present invention, the displaying the external device state menu comprises displaying the storing-enabled external device item and the storing-disabled external device item differently in color from each other.

According to an aspect of the present invention, the first through sixth icons are different in color, and one of the first through sixth icons is displayed at one icon displaying position according to a predetermined priority.

According to an aspect of the present invention, the plurality of external devices and the image processing apparatus are connected through an IEEE 1394 communication cable.

According to an aspect of the present invention, the displaying the external device state menu comprises displaying the plurality of external device items to be arranged on the external device state menu in a predetermined arranging direction, and displaying a first directional item and a second directional item to move the plurality of external device items on the external device state menu along the arranging direction in the case where the number of external device items to be displayed is larger than the number of external device items displayable on the external device state menu.

According to an aspect of the present invention, the displaying the external device state menu comprises displaying the plurality of external device items to be arranged in a lengthwise direction; moving the plurality of external device items on the external device state menu in an upward direction to make a hidden external device item appear as the lowest external device item on the external device state menu when a selection (−) key for downward movement is input in the state that the lowest external device item is pointed among the plurality of external device items displayed on the external device state menu; and moving the plurality of external device items on the external device state menu in a downward direction to make a hidden external device item appear as the highest external device item on the external device state menu when a selection (+) key for upward movement is input in the state that the highest external device item is pointed among the plurality of external device items displayed on the external device state menu.

The foregoing and/or other aspects of the present invention can be achieved by providing an image processing apparatus comprising a communicator to which a plurality of external devices is connected, a user input part, and a signal processor to process a video signal to be stored in the plurality of external devices, the image processing apparatus further comprising a memory to store state data about operation states of the plurality of external devices; a UI generator to generate an external device state menu including a plurality of external device items for representing the operation states of the plurality of external devices; and a controller to control the UI generator to display the external device state menu on the basis of the state data stored in the memory when a function related to storing the video signal is selected through the user input part.

According to an aspect of the present invention, the controller requests state data from the plurality of external devices when the function related to storing the video signal is selected through the user input part, and controls the memory to store the received state data when the requested state data is received.

According to an aspect of the present invention, the controller controls the UI generator to display storing-enabled external devices and storing-disabled external devices among the plurality of external devices as storing-enabled external device items and storing-disabled external device items, respectively, on the basis of the state data stored in the memory while displaying the external device state menu.

According to an aspect of the present invention, the image processing apparatus further comprises a signal receiver to receive EPG information, and wherein the controller controls the UI generator to display an EPG information picture based on the received EPG information when a function for displaying a predetermined EPG information picture is selected through the user input part, and display the external device state menu when a program to be stored is selected on the EPG information picture.

According to an aspect of the present invention, the controller controls the UI generator to display the external device items corresponding to the external devices, which are reproducing or storing another program, as the storing-disabled external device item with a first icon for representing a reproducing/storing state on the basis of the state data while displaying the external device state menu.

According to an aspect of the present invention, the controller controls the UI generator to display the external device items corresponding to the external devices, which have no storing medium for storing the video signal, as the storing-disabled external device item with a second icon for representing a no storing medium state on the basis of the state data while displaying the external device state menu.

According to an aspect of the present invention, the controller controls the UI generator to display the external device items corresponding to the external devices, which are provided with the storing medium having a remaining storing capacity smaller than that required for storing the video signal corresponding to the selected program, as the storing-disabled external device item with a third icon for representing a storing capacity deficiency on the basis of the state data while displaying the external device state menu.

According to an aspect of the present invention, the controller controls the UI generator to display the external device items corresponding to the external devices, which are abnormally operated, as the storing-disabled external device item with a fourth icon for representing an error state on the basis of the state data while displaying the external device state menu.

According to an aspect of the present invention, the state data includes at least one information among information about whether the external device are currently reproducing another program and storing another program, information about whether the external device is provided with a storing medium, information about a remaining storing capacity of the storing medium, and information about whether the external device normally performs the storing operation.

According to an aspect of the present invention, the image processing apparatus further comprises a sensor to sense whether the plurality of external devices is connected to the communicator, and wherein the controller controls the UI generator to display the external device items corresponding to the external devices, which are not connected to communicator, as the storing-disabled external device item with a fifth icon for representing a disconnected state on the basis of the sensed result.

According to an aspect of the present invention, the controller determines whether a program to be stored is selected on the EPG information picture through the user input part and whether a storing-device selecting function is selected to select the external device for storing the video signal of the selected program, and controls the UI generator to display the external device state menu when the storing-device selecting function is selected.

According to an aspect of the present invention, the user input part comprises an information key to check the state data, and the controller controls the UI generator to display an icon explanation picture about operation states corresponding to the first through fifth icons when the information key is input.

According to an aspect of the present invention, the controller controls the UI generator to display the state data corresponding to a pointed external device item when the information key is input in the state that one of the external device items corresponding to the plurality of external devices is pointed.

According to an aspect of the present invention, the controller controls the UI generator to display the storing-enabled external device item and the storing-disabled external device item of the external device state menu to be different in color from each other.

According to an aspect of the present invention, the controller controls the UI generator to display the first through fifth icons to be different in color from each other, and display one of the first through fifth icons at one icon displaying position according to a predetermined priority.

According to an aspect of the present invention, the image processing apparatus communicates with the plurality of external devices connected to the communicator through an IEEE 1394 communication cable.

### BRIEF DESCRIPTION OF THE DRAWINGS

The above and/or other aspects of the present invention will become apparent and more readily appreciated from the following description of the exemplary embodiments, taken in conjunction with the accompany drawings of which:

FIG. 1 is a control block diagram of an image processing apparatus and an image storing system having the same according to an exemplary embodiment of the present invention;

FIG. 2 illustrates an example of a TV guide in an EPG information picture;

FIGS. 3A to 3C illustrate examples of an external device state menu according to an exemplary embodiment of the present invention;

FIGS. 4A and 4B illustrate examples of an icon caption picture and a state data picture, respectively, when an information key according to an exemplary embodiment of the present invention is input; and

FIGS. 5A, 5B, 6A and 6B are flowcharts of controlling the image processing apparatus and the image storing system having the same according to an exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to like elements throughout. The exemplary embodiments are described below in order to explain the present invention by referring to the figures.

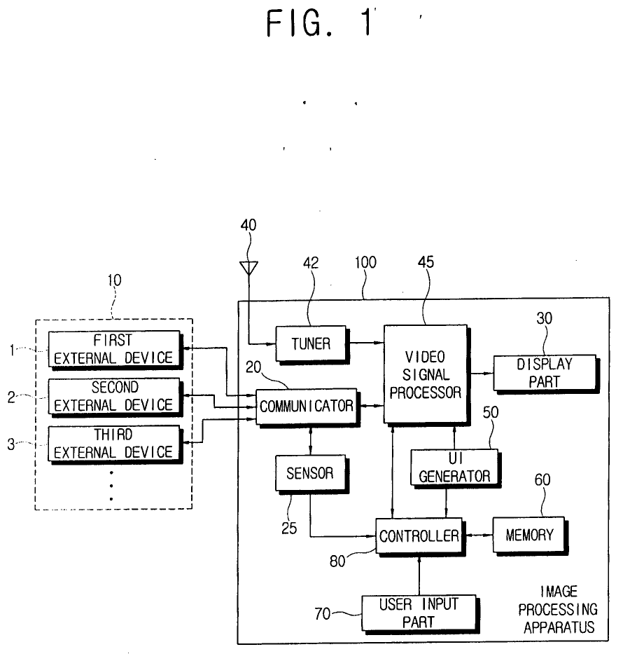

FIG. 1 is a control block diagram of an image processing apparatus 100 and an image storing system having the same according to an embodiment of the present invention. As shown in FIG. 1, the image storing system according to an embodiment of the present invention includes the image processing apparatus 100, and a plurality of external devices 10 connected to the image processing apparatus 100 and storing a video signal transmitted from the image processing apparatus 100.

Referring to FIG. 1, the plurality of external devices 10 includes a first external device 1, a second external device 2, and a third external device 3, and so on. Here, the plurality of external devices 10 may be achieved by a digital versatile disc (DVD) player, an audio/visual hard disk drive (AV-HDD), a digital home video system (D-VHS), etc.

According to an exemplary embodiment of the present invention, the image processing apparatus 100 includes a communicator 20, a sensor 25, a tuner 42, a video signal processor 45, a display part 30, a memory 60, a user input part 70, a user interface (UI) generator 50, and a controller 80.

The communicator 20 can include a connection port to receive an external video signal as well as a broadcasting signal, and a connection port to which the plurality of external devices 10 is connected. For example, the communicator 20 includes an analog connection port to receive an analog video signal such as a composite video baseband signal (CVBS), an S-video signal, or the like, and a digital connection port to receive a digital video signal such as a digital video interactive (DVI) signal or the like. Here, the digital connection port includes an IEEE 1394 port to which the plurality of external devices 10 such as the AV HDD and the D-VHS are connected. Thus, the image processing apparatus 100 and the plurality of external devices 10 interactively communicate with each other through an IEEE 1394 communication cable connected to the IEEE 1394 port.

The video signal processor 45 converts the video signal such as the CVBS signal, the S-video signal or the like input from the communicator 20, and the broadcasting input from the tuner 42 into the video signal that is processible in the display part 30. Here, the video signal processor 45 includes a channel decoder (not shown) demodulating an intermediate frequency (IF) broadcasting signal of the digital broadcasting signal output from the tuner 42, which selects the broadcasting signal received through the antenna 40, into a predetermined transport stream; a TP decoder (not shown) decoding the transport stream output from the channel decoder and outputting a program information corresponding to a channel changed by a user and a predetermined video signal sequence; and a video decoder (not shown) receiving the video signal sequence from the TP decoder, and extracting and restoring the video signal sequence into an original video signal. Further, the video signal processor 45 synthesizes the processed video signal with a menu signal corresponding to an external device state menu generated by the UG generator 50, and output it to the display part 30.

Also, the video signal processor 45 is controlled by the controller 80 to process the video signal to have a format to be stored in the plurality of external devices 10 and output it to the plurality of external devices 10 through the communicator 20.

The sensor 25 outputs a sensed signal to the controller 80 according to whether the plurality of external devices 10 is connected to the communicator 20.

The memory 60 stores state data about the operation state of the plurality of external devices 10. Here, the state data includes information about whether the plurality of external devices 10 is in a reproducing state of currently reproducing another program; information about whether the plurality of external devices 10 is in a storing state of currently storing another program; information about whether the plurality of external devices 10 is provided with a storage medium to store an image; information about a remaining storable capacity of the storage medium; information about whether the plurality of external devices 10 can be operated normally or not; etc.

The user input part 70 outputs a key signal to the controller 80 according to a user's manipulation. Here, the user input part 70 can include an EPG key to display an EPG information picture, a menu key to select functions related to storing the video signal, and a navigation key (e.g., (+)/(−)) for pointing or selecting items of the menu. Further, the user input part 70 can be achieved by a separately connected input means such as a mouse, a keyboard, etc. or a wireless remote controller. Thus, the controller 80 controls the video signal processor 45, the UI generator 50 and the like according to the key signal input through the user input part 70.

The UI generator 50 generates the external device state menu according to the control of the controller 80, in which the external device state menu showing the respective operation states of the external devices 10 for storing the video signal. Further, the UI generator 50 generates the EPG information picture according to the control of the controller 80. Thus, the UI generator 50 can generate various UI pictures according to the controls of the controller 80. As shown in FIG. 1, the UI generator 50 can be provided separately from the video signal processor 45, but alternatively, the UI generator 50 may be included in the video signal processor 45.

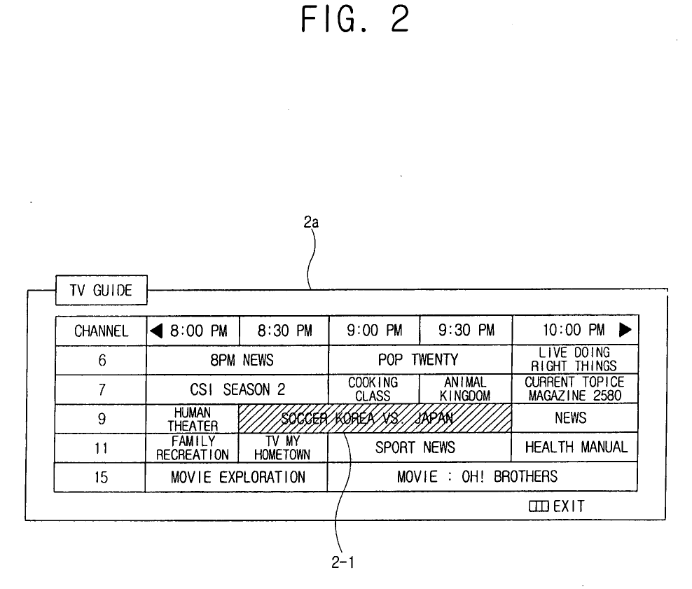

The controller 80 controls the UI generator 50 to display the EPG information picture when the EPG key is input according to a user's manipulation. Here, the controller 80 can extract the EPG information from the transport stream output from the channel decoder, in which the EPG information contains various channel information such as a title, a genre, a start time, an end time, etc. of a reproducing program based on a broadcasting signal. Thus, the controller 80 controls the UI generator 50 to generate an EPG information picture (refer to “TV guide” 2a of FIG. 2) on the basis of the extracted EPG information.

The controller 80 determines whether one program (e.g., “soccer Korea vs. Japan” 2-1) is selected on the EPG information picture (refer to “TV guide” 2a of FIG. 2) through the navigation (+)/(−) key of the user input part 70, and the menu key is input for selecting the functions related to storing the video signal. Further, the controller 80 requests the state data from the plurality of external devices 10 when the menu key is input. Thus, the plurality of external devices 10 transmits the state data to the controller 80 in response to the request, and then the controller 80 controls the memory 60 to store the received state data. Alternatively, regardless of the menu key for selecting the storing-related functions, the controller 80 may periodically requests the state data from the plurality of external devices 10 at predetermined intervals and control the memory 60 to store the received state data.

Meanwhile, when the menu key for selecting the storing-related functions is input through the user input part 70, the controller 80 determines whether the storing (duplication) operation of the selected program 2-1 is copyright protected on the basis of the EPG information extracted from the transport stream. In the case where the controller 80 determines that the storing (duplication) operation for the selected program 2-1 is not allowed, it controls the UI generator 50 to display a storing-disability message informing a user that the selected program 2-1 is a storing-disable program. The UI generator 50 displays the storing-disability message for a predetermined time (about 3 seconds), and then displays the EPG information picture (refer to “TV guide” 2a of FIG. 2).

Thereafter, the controller 80 determines whether a storing-device selecting function for selecting the external device to store the video signal of the program 2-1 selected through the user input part 70 therein is selected or not. When the storing-device selecting function is selected, the controller 80 controls the UI generator 50 to display the external device state menu showing the operating states corresponding to the plurality of external devices 10 on the basis of the state data stored in the memory 60. Here, the controller 80 can be achieved by a micom or the like.

The external device state menu is displayed as follows. On the basis of the state data stored in the memory 60 when the external device state menu is displayed, the controller 80 controls the UI generator 50 to display the external devices as external device items by dividing the items into storing-enabled external device items and storing-disabled external device items. Preferably, but not necessarily, the storing-enabled external device items are displayed with a white color, and the storing-disabled external device items are displayed with a gray color. Further, the external device items are preferably, but not necessarily, arranged in a predetermined direction (a transverse or lengthwise direction).

That is, while the external device state menu is displayed, the controller 80 controls the UI generator 50 to display the external device items corresponding to the external devices, which are reserved for storing another program when another program is reproduced/stored or when the selected program 2-1 is reproduced, on the basis of the state data stored in the memory 60. At this time, the external device items including a first icon for representing a reproducing/storing state are displayed as the storing-disable external device item (with the gray color).

Further, while the external device state menu is displayed, the controller 80 controls the UI generator 50 to display the external device items corresponding to the external devices, which have no storing medium for storing the video signal, on the basis of the state data stored in the memory 60. At this time, the external device items including a second icon for representing no storing medium is displayed as the storing-disabled external device item (with the gray color).

Also, while the external device state menu is displayed, the controller 80 determines whether the remaining storable capacity of the provided storing medium is smaller than the capacity required for storing the video signal corresponding to the selected program 2-1 on the basis of the state data stored in the memory 60. Consequently, when the remaining storable capacity of the provided storing medium is smaller than the capacity required for storing the video signal corresponding to the selected program 2-1, the controller 80 controls the UI generator 50 to display the external device item corresponding to the external device provided with the storing medium. At this time, the external device item including a third icon for representing a capacity deficiency is displayed as the storing-disabled external device item (with the gray color).

Additionally, while the external device state menu is displayed, the controller 80 controls the UI generator 50 to display the external device items corresponding to abnormal external devices, of which the storing operation is disabled, on the basis of the state data stored in the memory 60. At this time, the external device item including a fourth icon for representing an error state is displayed as the storing-disabled external device item (with the gray color).

Besides, while the external device state menu is displayed, the controller 80 controls the UI generator 50 to display the external device items corresponding to abnormal external devices, which are not connected to the communicator 20, on the basis of the sensed signal of the sensor 25. At this time, the external device item including a fifth icon for representing a disconnected state is displayed as the storing-disabled external device item (with the gray color).

Here, while the external device state menu is displayed, the controller 80 controls the first through fifth icons to be displayed with different colors. Preferably, but not necessarily, the controller 80 controls the UI generator 50 to display one of the first through fifth icons at an icon displaying position according to a predetermined priority so as to display a plurality of icons among the first through fifth icons. For example, the first icon is red; the second icon is orange; the third icon is yellow; the fourth icon is green; and the fifth icon is blue. Further, the priority of displaying the icon at one icon displaying position may be determined as <fifth icon->fourth icon->second icon->third icon->first icon>, in which the fifth icon and the first icon have a highest priority and a lowest priority, respectively. For example, in the case where the external device corresponding to one external device item is not only provided with the storing medium having a deficient storable capacity (i.e., the third icon) but also currently reproducing another program (with the first icon), only the third icon may be displayed according to the priority.

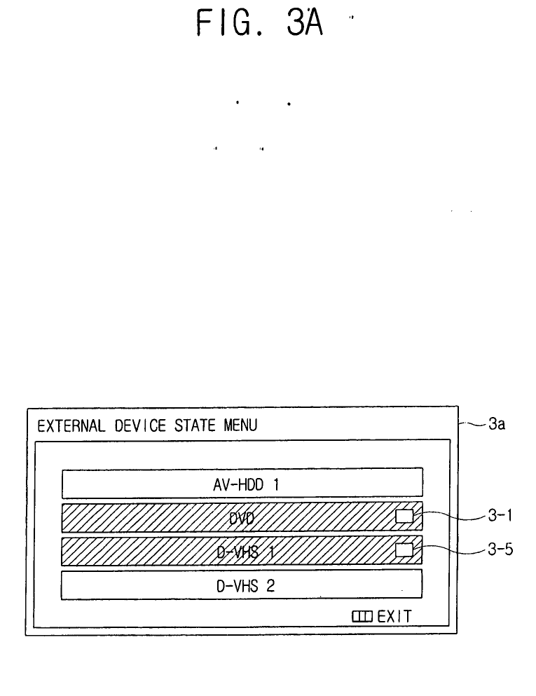

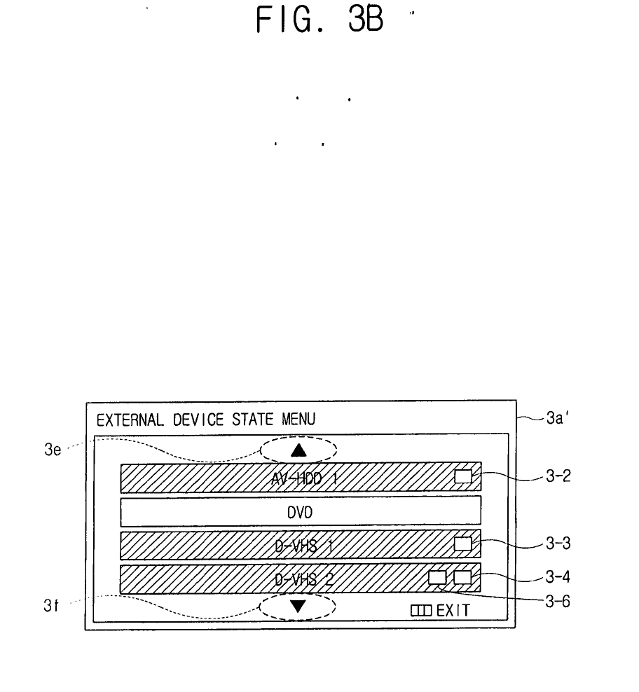

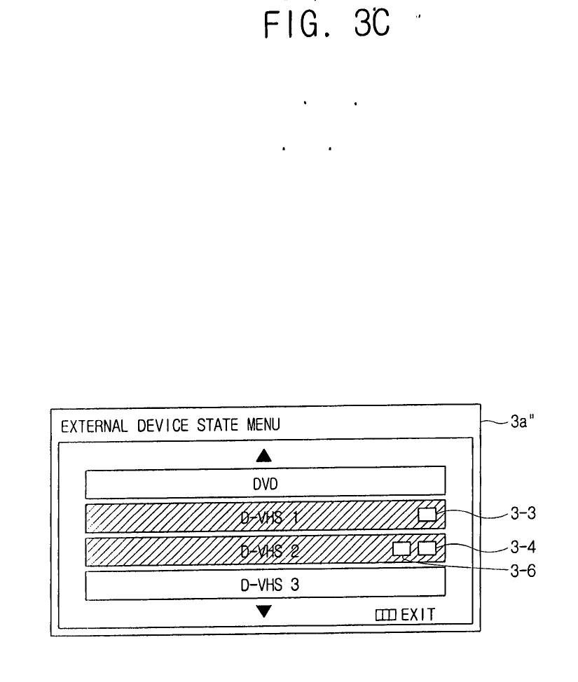

Referring to FIG. 3A, an external device state menu 3a containing the storing-disabled external device items (gray) with the first through fifth icons and the storing-enable external device items (white) will be described.

The external device state menu 3a arranges a plurality (four) of external device items (e.g., an AV-HDD1 item, a DVD item, a D-VHS1 item, and a D-VHS2 item) thereon in the lengthwise direction. Among the plurality of external device items, the AV-HDD1 item and the D-VHS2 item are illustrated as the storing-enabled external device item (white), and the DVD item and the D-VHS1 item are illustrated as the storing-disabled external device item (gray). In other words, the external devices corresponding to the AV-HDD1 item and the D-VHS2 item can store the selected program 2-1, but the external devices corresponding to the DVD item and the D-VHS1 item cannot store the selected program 2-1.

In more detail, the image storing system based on the external device state menu 3a is as follows. The external device (e.g., a first digital image storage) corresponding to the D-VHS1 item is not connected to the communicator 20, so that the D-VHS1 item is displayed as the storing-disabled external device item (gray) including the fifth icon 3-5 for representing the disconnected state. Further, the external device (e.g., a DVD player) corresponding to the DVD item is reserved for storing another program when another program is reproduced/stored or when the selected program 2-1 is reproduced, so that the DVD item is displayed as the storing-disabled external device item (gray) including the first icon 3-1 for representing the reproducing/storing state. Also, the external devices corresponding to the AV-HDD1 item and the D-VHS2 item can store the selected program 2-1, so that the AV-HDD1 item and the D-VHS2 item are displayed as the storing-enabled external devices (white).

Thus, a user can easily check the respective states of the external devices through the external device state menu 3a according to an embodiment of the present invention displayed when the external device is selected for storing the desired program 2-1.

Here, the controller 80 can determine whether the external device for storing the video signal abnormally stops the storing operation. Such abnormal stop of the storing operation may occur when the storing medium provided in the external device has a deficient storing capacity or when the external device is accidentally turned off during the storing operation. Thus, the abnormal stop of the storing operation may occur due to the operation error of the external device performing the storing operation. When the storing operation is abnormally stopped due to the operation error of the external device, the external device outputs an abnormal stop signal for warning of an error in the storing operation to the image processing apparatus 100. As the controller 80 receives the abnormal stop signal from the external device, the controller 80 regards the external device outputting the abnormal stop signal as the external device of which the storing operation is abnormally stopped. Further, while the image processing apparatus 100 provides the external device with the video signal to be stored in the external device, when the image processing apparatus 100 is turned off or when it is determined that the external device is separated from the image processing apparatus 100 on the basis of the sensed signal of the sensor 25, the controller 80 regards the external device performing the storing operation as the external device of which the storing operation is abnormally stopped.

Thus, while the external device state menu is displayed, the controller 80 controls the UI generator 50 to display the external device item corresponding to the external device, which is regarded as the external device of which the storing operation is abnormally stopped. At this time, the external device item is displayed as the storing-disabled external device item (gray) including a sixth icon for representing an abnormally stopped state.

Referring to FIG. 3B, an external device state menu 3a′ containing the storing-disabled external device items (gray) with the first through sixth icons and the storing-enabled external device items (white) will be described.

The external device state menu 3a′ arranges a plurality (four) of external device items (e.g., an AV-HDD1 item, a DVD item, a D-VHS1 item, and a D-VHS2 item) thereon in the lengthwise direction. Among the plurality of external device items, the DVD item is illustrated as the storing-enabled external device item (white), and the AV-HDD1 item, the D-VHS1 item and a D-VHS2 item are illustrated as the storing-disabled external device item (gray). In other words, the external devices corresponding to the AV-HDD1 item and the D-VHS2 item can store the selected program 2-1, but the external devices corresponding to the DVD item and the D-VHS1 item cannot store the selected program 2-1.

In more detail, the image storing system based on the external device state menu 3a′ is as follows. The external device (e.g., a first hard disk drive) corresponding to the AV-HDD1 item has no storing medium for storing the video signal, so that the AV-HDD1 item is displayed as the storing-disabled external device item (gray) including the second icon 3-2 for representing a no storing medium state. The external device (e.g., the first digital image storage) corresponding to the D-VHS1 item includes the storing medium having a smaller remaining capacity than that required for storing the video signal of the selected program 2-1, so that the D-VHS1 item is displayed as the storing-disabled external device (gray) with the third icon 3-3 for representing the storing capacity deficiency. The external device (e.g., the second digital image storage) corresponding to the D-VHS2 item cannot be normally operated, so that the D-VHS2 item is displayed as the storing-disabled external device item (gray) with the fourth icon 3-4 for representing the error state. Here, the external device (e.g., the second digital image storage) corresponding to the D-VHS2 item is remembered as the external device of which the previous storing operation is abnormally stopped, so that the D-VHS2 item is displayed as the storing disabled external device item (gray) with the sixth icon 3-6 for representing the abnormally stopped state. On the other hand, the external device (e.g., the DVD player) corresponding to the DVD item can store the selected program 2-1, so that the DVD item is displayed as the storing-enabled external device item (white).

Thus, a user can easily check the storable states and the abnormally stopped states of the respective external devices through the external device state menu 3a′ according to an embodiment of the present invention displayed when the external device is selected for storing the program 2-1.

Preferably, but not necessarily, the sixth icon 3-6 is displayed on the external device state menu first displayed after the corresponding external device abnormally stops the storing operation, but not displayed on the next displayed external device state menu.

In the case where the number (e.g., five) of external device items to be displayed is larger than the number (e.g., four) of external device items displayable on the external device state menu 3a′, the UI generator 50 may display a directional (‘▴’) item 3e and a directional (‘▾’) item 3f on the top portion and the bottom portion of four external device items (the AV-HDD1 item, the DVD item, the D-VHS1 item and the D-VHS2 item) arranged in the lengthwise direction, respectively. Thus, a user checks the directional (‘▴’) item 3e and the directional (‘▾’) item 3f, and recognizes that there are another external device items which are not displayed on the external device state menu 3a′.

Thus, while the external device items (the AV-HDD1 item, the DVD item, the D-VHS1 item and the D-VHS2 item) are pointed by manipulating the navigation (+) key and the navigation (−) key of the user input part 70, when the navigation (−) key for downward movement is input in the state that the lowest external device item (D-VHS2 item) is pointed among the external device items (the AV-HDD1 item, the DVD item, the D-VHS1 item and the D-VHS2 item) displayed on the external device state menu 3a′, the controller 80 controls the UI generator 50 to move the plurality of external device items (the AV-HDD1 item, the DVD item, the D-VHS1 item and the D-VHS2 item) displayed on the external device state menu 3a′ in an upward direction.

Further, when the navigation (+) key for upward movement is input in the state that the highest external device item (AV-HDD1 item) is pointed among the external device items (the AV-HDD1 item, the DVD item, the D-VHS1 item and the D-VHS2 item) displayed on the external device state menu 3a′, the controller 80 controls the UI generator 50 to move the plurality of external device items (the AV-HDD1 item, the DVD item, the D-VHS1 item and the D-VHS2 item) displayed on the external device state menu 3a′ in a downward direction.

Such movement for the plurality of external device items will be described with reference to the external device state menu 3a′ of FIG. 3B and an external device state menu 3a″ of FIG. 3C.

When the navigation (−) key for the downward movement is selected in the state that the lowest external device item (D-VHS2 item) is pointed among the external device items (the AV-HDD1 item, the DVD item, the D-VHS1 item and the D-VHS2 item) displayed on the external device state menu 3a′, the plurality of external device items (the AV-HDD1 item, the DVD item, the D-VHS1 item and the D-VHS2 item) moves upward line by line. Therefore, like the external device state menu 3a″, the highest external device item (AV-HDD1 item) displayed on the external device state menu 3a′ disappears beyond the highest line thereof, and the external device item (D-VHS3 item) hidden in the external device state menu 3a′ appears under the D-VHS2 item. Likewise, when the navigation (+) key is selected, the movement is implemented in an opposite direction.

Thus, in the case where it is impossible to display all external device items on one external device state menu because of many external devices, the directional (‘▴’) item 3e and the directional (‘▾’) item 3f are displayed, thereby allowing a user to know that there are another external device items which are not shown on the external device state menu 3a′. Further, the navigation (+) key and the navigation (−) key are manipulated to implement a scroll function for moving the external device items, so that the hidden external device items can be shown on the external device state menu, thereby allowing a user to effectively check the state of each external device.

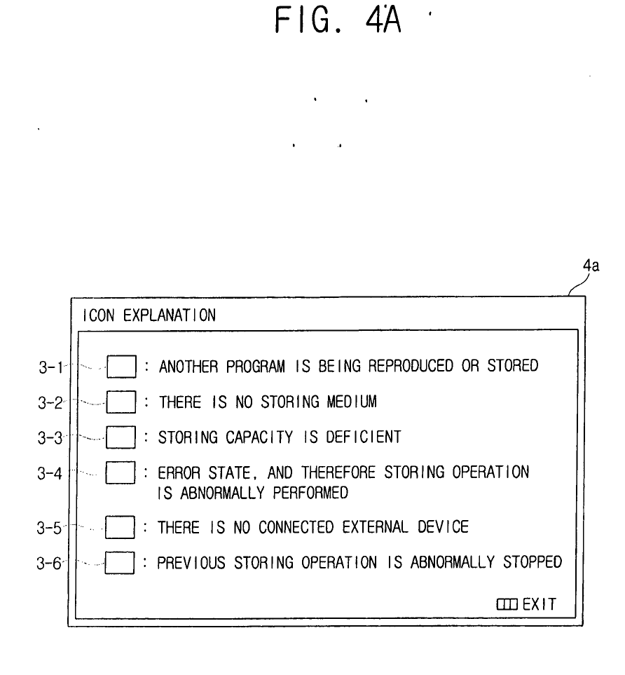

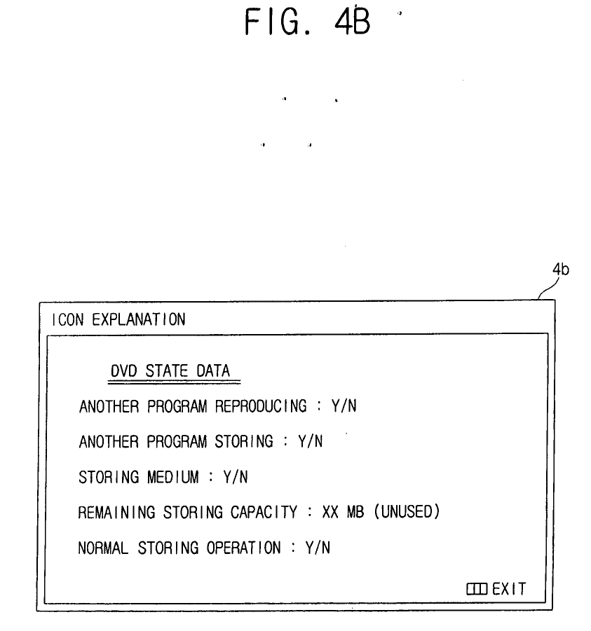

In the meantime, the user input part 70 can further include an information key for checking the state data. Thus, when the information key is selected through the user input part 70 in the state that the external device state menu is displayed, the controller 80 controls the UI generator 50 to display an icon explanation picture 4a, as shown in FIG. 4A, for explaining the operation states represented by the fist icon 3-1 through the sixth icon 3-6. As shown in FIG. 4A, the icon explanation picture 4a is preferably, but not necessarily displayed as a text picture for explaining the operation states corresponding to the fist icon 3-1 through the sixth icon 3-6.

Further, when the information key is selected in the state that one of the external device items is pointed on the external device state menu, the controller 80 controls the UI generator 50 to display a state data picture of the external device corresponding to the pointed external device item. For example, when the information key is selected in the state that the DVD item is pointed on the external device state menu 3a′ through the navigation (+)/(−) key of the user input part 70, the controller 80 controls the UI generator 50 to display the state data picture 4b of the external device (e.g., the DVD player) corresponding to the DVD item, as shown in FIG. 4B. Here, the state data picture 4b can show information about whether the external device (DVD player) corresponding to the pointed external device item (DVD) is reproducing/storing another program; information about whether there is a storing medium for storing an image; information about the remaining storing capacity of the storing medium; information about whether the storing operation of the external device is normal or abnormal; information about whether the external device is connected to or disconnected from the communicator 20; and information about whether the storing operation is stopped normally or abnormally. Further, when an exit function is selected (e.g., an exit key is input or an exit item selected) in the state that the icon explanation picture 4a or the state data picture 4b is displayed, not the icon explanation picture 4a or the state data picture 4b but the previous displayed external device state menu is displayed.

When the external device (DVD player) is selected on the external device state menu for storing the video signal of the program 2-1 through the user input part 70, the controller 80 controls the video signal processor 45 to encode the video signal corresponding to the program (soccer Korea vs. Japan) 2-1 to have a predetermined format suitable for the external device (DVD player), and transmits the encoded video signal to the external device (DVD player) through the IEEE 1394 cable.

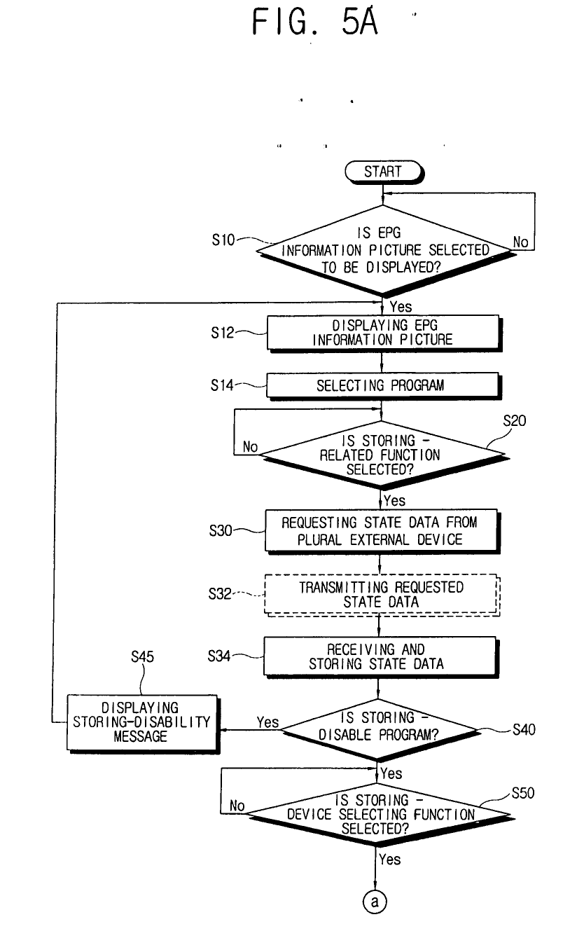

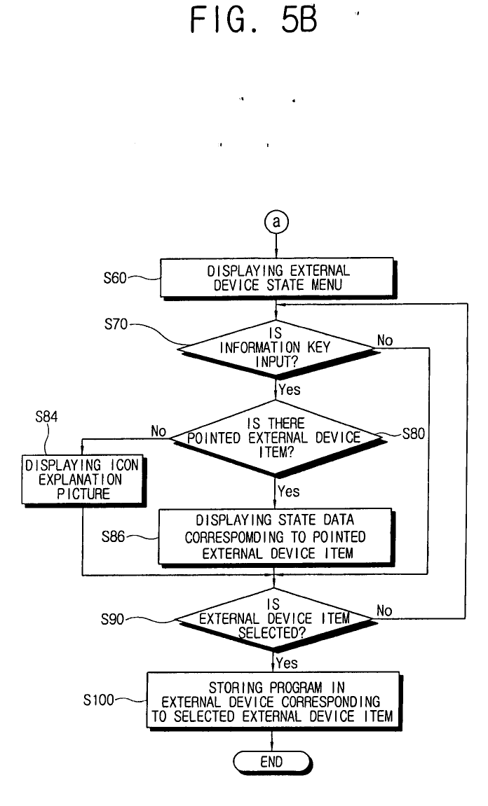

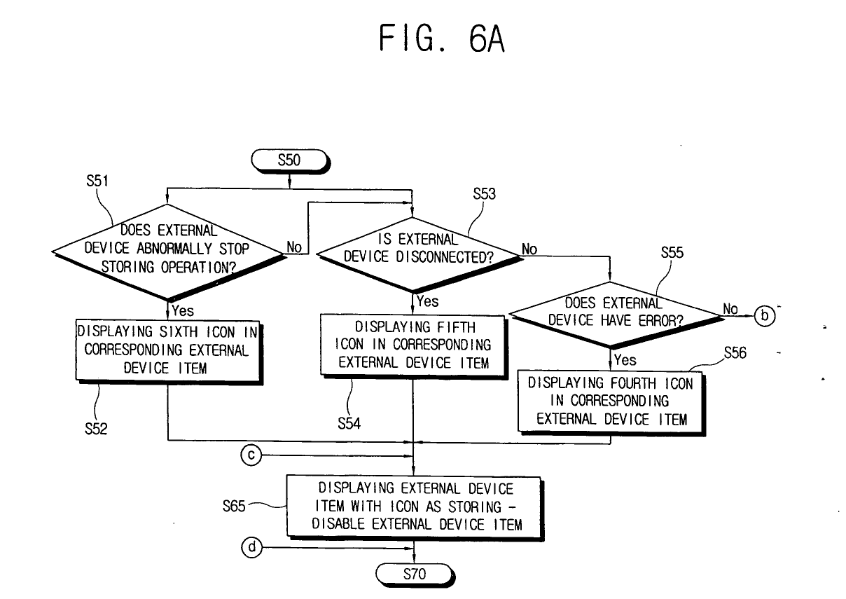

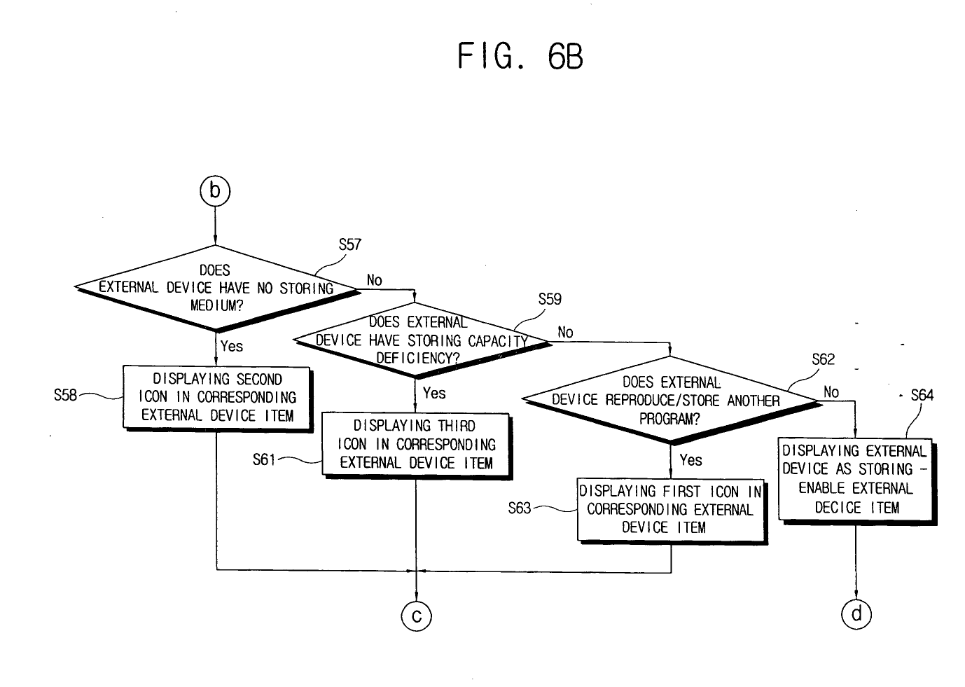

According to an embodiment of the present invention, the image processing apparatus 100 and the control method for the image storing system having the same will be described below with reference to FIGS. 5A, 5B, 6A and 6B.

First, at operation S10, the controller 80 determines whether the EPG key is input through the user input part 70. When it is determined that the EPG key is input at operation S12, the controller 80 controls the UI generator 50 to display the EPG information picture at operation S12. Here, the controller 80 can extract the EPG information from the transport stream output from the channel decoder (not shown) of the video signal processor 45. At operation S14, a user manipulates the navigation (+)/(−) key of the user input part 70 to select one program 2-1 (e.g., soccer Korean vs. Japan) on the EPG information picture. At operation S20, the controller 80 determines whether the menu key for selecting the storing-related function for the video signal is input through the user input part 70.

When the menu key is input, at operation S30 the controller 80 requests the state data from the plurality of external devices 10. At operation S32 the plurality of external devices 10 transmits the state data to the controller 80 in response to the request, and at operation S34 the controller 80 controls the memory 60 to store the transmitted state data. Alternatively, regardless of the menu key for selecting the storing-related functions, the controller 80 may periodically request the state data from the plurality of external devices 10 at predetermined intervals and control the memory 60 to store the received state data. While performing the operations S30 through S34, the controller 80 checks which external devices are disconnected from the communicator 20 on the basis of the sensed signal of the sensor 25, and which external devices are abnormally stopped during the previous storing operation.

At operation S40, the controller 80 determines whether the storing (duplication) operation of the selected program 2-1 is copyright protected or not on the basis of the EPG information of the program 2-1 selected at the operation SI 4. In the case where the controller 80 determines that the storing (duplication) operation for the selected program 2-1 is not allowed, at operation S45, the controller 80 controls the UI generator 50 to display the storing-disability message informing a user that the selected program 2-1 is the storing-disabled program. Here, the UI generator 50 displays the storing-disability message for a predetermined time (about 3 seconds), and then enters the operation S12 to display the EPG information picture.

On the other hand, in the case where the controller 80 determines that the storing (duplication) operation for the selected program 2-1 is allowed, at operation S50 the controller 80 determines whether the storing-device selecting function for selecting the external device to store the video signal of the program 2-1 selected through the user input part 70 therein is selected or not. When the storing-device selecting function is selected, at operation S60 the controller 80 controls the UI generator 50 to display the external device state menu showing the operating states corresponding to the plurality of external devices 10 on the basis of the state data stored in the memory 60, information about the external devices disconnected from the communicator 20, and information about the external devices of which the storing operation is abnormally stopped during the previous storing operation.

Below, the operation S60 of displaying the external device state menu will be described in more detail with references to FIGS. 6A and 6B.

While the external device state menu is displayed, at operation S51 the controller 80 determines which external devices are abnormally stopped during the previous storing operation on the basis of the checked information about the external devices of which the storing operation is abnormally stopped. Then, at operation S52 the controller 80 controls the UI generator 50 to display the external device item corresponding to the external device, of which the previous storing operation is abnormally stopped, along with the sixth icon 3-6 for representing the abnormally stopped state. Then, at operation S65, the controller 80 controls the UI generator 50 to display the external device item with the sixth icon 3-6 as the storing-disabled external device item (gray).

Here, while performing the operation S51, at operation S53 the controller 80 determines which external devices are disconnected from the communicator 20 on the basis of the sensed signal of the sensor 25. At operation S54, the controller 80 controls the UI generator 50 to display the external device item corresponding to the external device disconnected from the communicator 20 along with the fifth icon 3-5 for representing the disconnected state. At operation S65, the controller 80 controls the UI generator 50 to display the external device item with the fifth icon 3-5 as the storing-disabled external device item (gray).

At operation S55, the controller 80 determines which external devices among the external devices connected to the communicator 20 are in the error state, i.e., which external devices cannot normally perform the storing operation on the basis of the state data stored in the memory. At operation S56, the controller 80 controls the UI generator 50 to display the external device item corresponding to the external device, which is determined as being in the error state, along with the fourth icon 3-4 for representing the error state. At operation S65, the controller 80 controls the UI generator 50 to display the external device item with the fourth icon 3-4 as the storing-disabled external device item (gray).

At operation S57, the controller 80 determines which external devices among the external devices that are determined at the operation S55 as not being in the error state have no storing medium for storing the video signal on the basis of the state data stored in the memory 60. At operation S58, the controller 80 controls the UI generator 50 to display the external device item corresponding to the external device having no storing medium along with the second icon 3-2 for representing the no storing medium state. At operation S65, the controller 80 controls the UI generator 50 to display the external device item with the second icon 3-2 as the storing-disabled external device item (gray).

At operation S59, the controller 80 determines whether the remaining storable capacity of the storing medium provided in the external device among the external devices that is determined at the operation S57 as having the storing medium is smaller than that required for storing the video signal corresponding to the selected program 2-1 on the basis of the state data stored in the memory 60. At operation S61, the controller 80 controls the UI generator 50 to display the external device items corresponding to the external device including the storing medium having a deficient storing capacity along with the third icon 3-3 for representing the storing capacity deficiency. At operation S65, the controller 80 controls the UI generator 50 to display the external device item with the third icon 3-3 as the storing-disabled external device item (gray).

At operation S62, the controller 80 determines which external devices among the external devices that are determined as having enough remaining storing capacity to store the selected program 2-1 are reproducing/storing another program or reserved for storing another program when the selected program 2-1 is being reproduced, on the basis of the state data stored in the memory 60. At operation S63, the controller 80 controls the UI generator 50 to display the external device items corresponding to the external devices that are reproducing/storing another program or reserved for storing another program when the selected program is being reproduced, along with the first icon 3-1 for representing the reproducing/storing state. At operation S65, the controller 80 controls the UI generator 50 to display the external device item with the first icon 3-1 as the storing-disabled external device item (gray).

At operation S64, the controller 80 controls the UI generator 50 to display the external device items corresponding to the external devices which are determined at the operation S62 as being not in the reproducing/storing state, as the storing-enabled external device item (white).

Thus, in the external device state menu of the image storing system according to an exemplary embodiment of the present invention, the external device items corresponding to the external device being in the storing-disabled state are represented as the storing-disabled external device item (gray) with one icon among the icons having the following priority: <fifth icon->fourth icon->second icon->third icon->first icon> in which the fifth icon and the first icon have a top priority and a bottom priority, respectively. Further, in the external device state menu of the image storing system according to an exemplary embodiment of the present invention, the external device items corresponding to the external devices, of which the previous storing operation is abnormally stopped, are displayed as the storing-disabled storing device (gray) including the sixth icon for representing the abnormally stopped state, regardless of displaying the first through fifth icons.

Here, the first icon is red; the second icon is orange; the third icon is yellow; the fourth icon is green; and the fifth icon is blue.

As described above referring to FIGS. 6A and 6B, after the external device state menu is displayed (refer to the operation S60 of FIG. 5B), a control method for the image storing system according to an exemplary embodiment of the present invention will be described with reference to FIG. 5B.

When the external device state menu is displayed at the operation S60, a user manipulates the navigation (+)/(−) key of the user input part 70, and points the external device item on the external device state menu. At operation S70, the controller 80 determines whether the information key for checking the state data is input through the user input part 70. In the case where the information key is input, at operation S80 the controller 80 determines whether there is a pointed external device item on the external device state menu. When there is no pointed external device item, at operation S84 the controller 80 controls the UI generator 50 to display the icon explanation picture 4a (refer to FIG. 4A) for explaining the operation states represented by the first icon 3-1 through the sixth icon 3-6. When there is the pointed external device item, at operation s86 the controller 80 controls the UI generator 50 to display the state data picture 4b (refer to FIG. 4B) corresponding to the pointed external device item. Here, the state data picture 4b (refer to FIG. 4B) can show information about whether the external device corresponding to the pointed external device item is reproducing/storing another program; information about whether there is a storing medium for storing an image; information about the remaining storing capacity of the storing medium; information about whether the storing operation of the external device is normal or abnormal; information about whether the external device is connected to or disconnected from the communicator 20; and information about whether the storing operation is stopped normally or abnormally.

Further, when the exit function is selected (e.g., an exit key is input or an exit item selected) in the state that the icon explanation picture 4a or the state data picture 4b is displayed, not the icon explanation picture 4a or the state data picture 4b but the previous displayed external device state menu is displayed.

At operation S90, the controller 80 determines whether the external device items for storing the video signal of the program 2-1 are selected on the external device state menu through the user input part 70. When the external device item is selected for storing the video signal, at operation S100 the controller 80 controls the video signal processor 45 to store the video signal of the program 2-1 in the external device corresponding to the selected external device item.

Consequently, according to an exemplary embodiment of the present invention, in the method for controlling the image storing system connected with the plurality of external devices capable of storing an image, the storing-enabled external device and the storing-disabled external device among the plurality of external devices are divided and shown. Further, the state data such as the disconnected state, the error state, the no storing medium state, the storing capacity deficiency state, another program reproducing/storing state, and the abnormally stopped state of the storing-disabled external device can be shown on the external device state menu. Thus, when a user wants to store a desirable program, the external device state menu shows the states of the plurality of external devices, thereby allowing a user to easily and effectively check the states of the plurality of external devices through the external device state menu.

As described above, the present invention provides an image processing apparatus and a control method of an image storing system having the same, in which a user can easily and effectively check states of a plurality of external devices when he/she manipulates a storing operation, so that the storing operation is more conveniently and reliably performed.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of controlling an image storing system comprising a plurality of external devices, and an image processing apparatus connected to the plurality of external devices, wherein the image storing system is capable of storing a video signal in the plurality of external devices, the method comprising:
requesting state data about operation states of the plurality of external devices if a function related to storing the video signal is selected;
receiving at the image processing apparatus the requested state data from the plurality of external devices; and
displaying an external device state menu showing the operation states of the plurality of external devices based on the received state data.

2. The method according to claim 1, wherein the displaying the external device state menu comprises:
displaying storing-enabled external devices and storing-disabled external devices among the plurality of external devices as storing-enabled external device items and storing-disabled external device items, respectively, based on the state data; and
displaying the storing-enabled external device items and the storing-disabled external device items differently from each other.

3. The method according to claim 2, further comprising:
selecting an Electronic Program Guide (EPG) information picture to be displayed; and
selecting a program for a storing operation on the displayed EPG information picture.

4. The method according to claim 3, wherein the displaying the external device state menu further comprises displaying the external device items corresponding to the external devices, which are reproducing or storing another program, as the storing-disabled external device item with a first icon for representing a reproducing or storing state based on the state data.

5. The method according to claim 4, wherein the displaying the external device state menu further comprises displaying the external device items corresponding to the external devices, which have no storing medium for storing the video signal, as the storing-disabled external device item with a second icon for representing a no storing medium state based on the state data.

6. The method according to claim 5, wherein the displaying the external device state menu further comprises displaying the external device items corresponding to the external devices, which are provided with the storing medium having a remaining storing capacity smaller than that required for storing the video signal corresponding to the selected program, as the storing-disabled external device item with a third icon for representing a storing capacity deficiency state based on the state data.

7. The method according to claim 6, wherein the displaying the external device state menu further comprises displaying the external device items corresponding to the external devices, which are abnormally operated, as the storing-disabled external device item with a fourth icon for representing an error state based on the state data.

8. The method according to claim 7, wherein the state data includes at least one of information about whether the external device are currently reproducing another program and storing another program, information about whether the external device is provided with a storing medium, information about a remaining storing capacity of the storing medium, and information about whether the external device normally performs the storing operation.

9. The method according to claim 8, further comprising determining whether the plurality of external devices are connected to the image processing apparatus, and
wherein the displaying the external device state menu further comprises displaying the external device items corresponding to the external devices, which are not connected to the image processing apparatus, as the storing-disabled external device item with a fifth icon for representing a disconnected state.

10. The method according to claim 9, further comprising determining whether a storing-device selecting function is selected to select the external device for storing the video signal of the selected program,
wherein the external device state menu is displayed if the storing-device selecting function is selected.

11. The method according to claim 10, further comprising determining whether the external device of storing the video signal is abnormally stopped, and
wherein the displaying the external device state menu further comprises displaying the external device items corresponding to the external devices, of which the storing operation is abnormally stopped, as the storing-disabled external device item with a sixth icon for representing an abnormally stopped state.

12. The method according to claim 11, further comprising:
determining whether an information key is input to check the state data; and
displaying an icon explanation picture about operation states corresponding to the first through sixth icons if the information key is input.

13. The method according to claim 12, further comprising:
determining whether the information key is input in the state that one of the external device items is currently pointed on the external device state menu; and
displaying the state data corresponding to the pointed external device item if the information key is input.

14. The method according to claim 13, further comprising determining whether the selected program is a storing-disabled program due to a copyright restriction based on the EPG information if the storing-device selecting function is selected; and
displaying a storing-disability message warning of the storing disability if the selected program is the storing-disabled program.

15. The method according to claim 14, wherein the displaying the external device state menu further comprises displaying the storing-enabled external device item and the storing-disabled external device item differently in color from each other.

16. The method according to claim 15, wherein the first through sixth icons are different in color, and
one of the first through sixth icons is displayed at an icon displaying position according to a predetermined priority.

17. The method according to claim 16, wherein the plurality of external devices and the image processing apparatus are connected through an IEEE 1394 communication cable.

18. The method according to claim 17, wherein the displaying the external device state menu further comprises displaying the plurality of external device items to be arranged on the external device state menu in an arranging direction, and displaying a first directional item and a second directional item to move the plurality of external device items on the external device state menu along the arranging direction in the case where a number of external device items to be displayed is larger than a number of external device items displayable on the external device state menu.

19. The method according to claim 18, wherein the displaying the external device state menu further comprises:
displaying the plurality of external device items to be arranged in a lengthwise direction;
moving the plurality of external device items on the external device state menu in an upward direction to make a hidden external device item appear as a lowest external device item on the external device state menu if a first selection key for downward movement is input in the state that the lowest external device item is pointed among the plurality of external device items displayed on the external device state menu; and
moving the plurality of external device items on the external device state menu in a downward direction to make a hidden external device item appear as a highest external device item on the external device state menu if a second selection key for upward movement is input in the state that the highest external device item is pointed among the plurality of external device items displayed on the external device state menu.

20. An image processing apparatus which stores a video signal in at least one of a plurality of external devices, the image processing apparatus comprising:
a user input part;
a memory which stores state data about operation states of the plurality of external devices;
a User Interface (UI) generator which generates an external device state menu including a plurality of external device items for representing the operation states of the plurality of external devices; and
a controller which controls the UI generator to display the external device state menu based on the state data stored in the memory if a function related to storing the video signal is selected through the user input part.

21. The image processing apparatus according to claim 20, wherein the controller requests the state data from the plurality of external devices if the function related to storing the video signal is selected through the user input part, and controls the memory to store the received state data if the requested state data is received.

22. The image processing apparatus according to claim 21, wherein the controller controls the UI generator to display storing-enabled external devices and storing-disabled external devices among the plurality of external devices as storing-enabled external device items and storing-disabled external device items, respectively, based on the state data stored in the memory while displaying the external device state menu.

23. The image processing apparatus according to claim 22, further comprising a signal receiver to receive Electronic Program Guide (EPG) information,
wherein the controller controls the UI generator to display an EPG information picture based on the received EPG information if a function for displaying an EPG information picture is selected through the user input part, and display the external device state menu if a program to be stored is selected on the EPG information picture.

24. The image processing apparatus according to claim 23, wherein the controller controls the UI generator to display the external device items corresponding to the external devices, which are reproducing or storing another program, as the storing-disabled external device item with a first icon for representing a reproducing or storing state based on the state data while displaying the external device state menu.

25. The image processing apparatus according to claim 24, wherein the controller controls the UI generator to display the external device items corresponding to the external devices, which have no storing medium for storing the video signal, as the storing-disabled external device item with a second icon for representing a no storing medium state based on the state data while displaying the external device state menu.

26. The image processing apparatus according to claim 25, wherein the controller controls the UI generator to display the external device items corresponding to the external devices, which are provided with the storing medium having a remaining storing capacity smaller than that required for storing the video signal corresponding to the selected program, as the storing-disabled external device item with a third icon for representing a storing capacity deficiency state based on the state data while displaying the external device state menu.

27. The image processing apparatus according to claim 26, wherein the controller controls the UI generator to display the external device items corresponding to the external devices, which are abnormally operated, as the storing-disabled external device item with a fourth icon for representing an error state based on the state data while displaying the external device state menu.

28. The image processing apparatus according to claim 27, wherein the state data includes at least one of information about whether the external device are currently reproducing another program and storing another program, information about whether the external device is provided with a storing medium, information about a remaining storing capacity of the storing medium, and information about whether the external device normally performs the storing operation.

29. The image processing apparatus according to claim 28, further comprising a sensor to sense connection of the plurality of external devices to the image processing apparatus,
wherein the controller controls the UI generator to display the external device items corresponding to external devices which are not connected to communicator as the storing-disabled external device item with a fifth icon for representing a disconnected state based on a sensed result of the sensor.

30. The image processing apparatus according to claim 29, wherein the controller determines whether a program to be stored is selected on the EPG information picture through the user input part and whether a storing-device selecting function is selected to select the external device for storing the video signal of the selected program, and controls the UI generator to display the external device state menu if the storing-device selecting function is selected.

31. The image processing apparatus according to claim 30, wherein the user input part comprises an information key to check the state data, and
the controller controls the UI generator to display an icon explanation picture about operation states corresponding to the first through fifth icons if the information key is input.

32. The image processing apparatus according to claim 31, wherein the controller controls the UI generator to display the state data corresponding to a currently pointed external device item if the information key is input in the state that one of the external device items corresponding to the plurality of external devices is pointed.

33. The image processing apparatus according to claim 32, wherein the controller controls the UI generator to display the storing-enabled external device item and the storing-disabled external device item of the external device state menu to be different in color from each other.

34. The image processing apparatus according to claim 33, wherein the controller controls the UI generator to display the first through fifth icons to be different in color from each other, and displays one of the first through fifth icons at an icon displaying position according to a predetermined priority.

35. The image processing apparatus according to claim 34, wherein the image processing apparatus communicates with the plurality of external devices through an IEEE 1394 communication cable.
